(19) United States
(12) Patent Application Publication
(10) Pub. No.: US 2009/0057210 A1
(43) Pub. Date: Mar. 5, 2009

(54) IN-LINE FILTRATION SYSTEMS

(76) Inventors: Kenneth Charles Barrett, Bristol, PA (US); Scott Boyette, New Hope, PA (US); Caibin Xiao, Harleysville, PA (US); Zhaoyang Wan, Yardley, PA (US)

Correspondence Address: General Electric Company;GE Global Patent Operation, PO Box 861, 2 Corporate Drive, Suite 648, Shelton, CT, 06484, US

(21) Appl. No.: 12/193,198

(22) Filed: Aug. 18, 2008

Related U.S. Application Data
(60) Provisional application No. 60/969,774, filed on Sep. 4, 2007.

(51) Int. Cl. B01D 61/58; B01D 35/22; B01D 35/157; C02F 1/00; B01D 35/30; B01D 36/00

(52) U.S. Cl. 210/85; 210/321.69; 210/143; 210/96.2

(57) ABSTRACT

A filtration system is disclosed that uses a combination of dead end filtration across opposing membranes with a sample take-off in the middle and cross-flow to prevent cake formation on these opposing filters. In one embodiment is a system that uses opposing filters with a central collection chamber that flips flow back and forth between the sides at a frequency that minimizes filter cake formation. In another embodiment, a combination flip-flip, cross flow system is disclosed. An additional embodiment discloses an actuator valve driven sampling system, in which valves collect the cross flow/counter flow filter cake samples as they are liberated from a filter surface and a quick through filter fluid pulse loosens the sample cake from the filter material. The invention increases effective operation time, allows for continuous filtration operation without interruption, and provides filtered samples that accurately represent the concentration of macromolecular species in industrial systems.

### CROSS REFERENCE TO RELATED APPLICATIONS

This application claims priority from U.S. Provisional Application Ser. No. 60/969774 entitled “IN-LINE FILTRATION SYSTEM” filed on Sep. 4, 2007, the entirety of which is incorporated by reference herein.

### BACKGROUND OF THE INVENTION

1. Field of the Invention

The present invention relates to an on-line analysis system for use in industrial processes, including, but not limited to industrial water process systems. In particular, it relates to a filtration system with a flip-flop function and a filtration system with a combination flip-flop, cross-flow function.

2. Description of Related Art

Many different types of industrial or commercial operations rely on large quantities of water for various reasons, such as for cooling systems, or to produce large quantities of wastewater, which need to be treated. These industries include, but are not limited to, agriculture, petroleum, chemical, pharmaceutical, mining, metal plating, textile, brewing, food and beverage processing, and semiconductor industries.

One type of filtration device consists of a filter which has an inlet and an outlet. The fluid being filtered enters via the inlet and flows through the filter, which removes and retains larger particles passing through the openings of the filter, but allows the “carrier” fluid, or filtrate. The filtrate then leaves via the outlet. This is often referred to as “dead end” filtration.

In the case of dead end filtration, the effective filtering area of the filtration device is larger than the inlet area. Thus, the speed of flow through the filter is much slower than the flow in the inlet, and the direction of the flow through the filter is perpendicular to the surface of the filter. This situation results in impurities, formation of a cake, and blocking on the openings of the filter, which cause the effective filtration area to be reduced. When the effective area of filter becomes smaller than the inlet area, the differential pressure (Δ P) between inlet and outlet increases. For typical applications, there is a maximum pressure drop allowed for the filtration device, and when the differential pressure reaches the maximum value, it is necessary to shut down the whole process to either change or clean the filter by removing the cake formed on the surfaces, or to switch to a different operation in order to avoid interruption.

Dead end filtration, in which the feed is passed through a membrane or bed, the solids being trapped in the filter and the filtrate being released at the other end, is different than crossflow filtration. In crossflow filtration, the feed is passed across the filter membrane, tangentially to the filter membrane, at some pressure difference. Material which is smaller than the membrane pore size passes through the membrane as permeate or filtrate, and everything else is retained on the feed side of the membrane as retentate. This mode of operation is used for high solids feeds because of the risk of blinding. With dead end filtration, solids material can quickly block or blind the filter surface. With crossflow filtration, the tangential motion of the bulk of the fluid across the membrane causes trapped particles on the filter surface to be rubbed off. This means that a crossflow filter can operate for longer times at relatively high solids loads without blinding.

Filtration is common among such processes to remove particulate matter and to remove components that may result in scaling or fouling of equipment. Many different methods of filtration can be used. Both cross-flow and dead end filtration are a common practice for industrial water processes, particularly when the process includes an on line sample component. However, these approaches can prove problematic for on-line analyzers because of plugging of the filters by particulate and suspended material. This plugging of the filters can occur with alarming frequency. And in fact, this becomes even more problematic as the pore size of the filter is reduced. The cross-flow filter design is less prone to plugging than a dead end filter, however, cross-flow filtration can still be susceptible to particulate accumulation and pluggage, but to a lesser degree.

One means of addressing this problem is to frequently change the filter. However, this approach requires costly manual filter replacement at inconvenient intervals. An alternate approach is a mechanical system that automatically changes the filter using a system devised for that purpose.

Although frequent filter changes address some of the concerns, it does not address all issues that arise. In particular, there is still the issue of accumulating materials on a filter that creates a sink for materials known to absorb or be trapped by the forming particulate beds. As an example, cooling tower water can contain high concentrations of inorganic particles of varying sizes, in addition to biological materials, both of which can accumulate on the surface of a filter. These materials are known to be active absorbents, and macromolecular material known to absorb onto these materials can be trapped in the accumulating filter cake. Therefore, the concentration that passes through the in-line filter into the detection system can actually decrease over time and produce an artificially decreasing response. This sample gradient can produce on-line signals that do not accurately represent the concentration in the original system. There are systems that can minimize macromolecular adsorption by frequently changing filters, but this often requires frequent operator intervention. In addition, these methods can be both time-consuming and costly.

Accordingly, a need exists for a system that improves macromolecular detection by preventing problems with macromolecular adsorption onto filter cakes formed on the filter membrane surface of in-line filtration systems.

In particular, a need exists for a cost-effective and time-saving membrane filtration process that provides a means for minimizing the clogging of filters in industrial systems, particularly water systems, which does not require as frequent a changing of filters nor the use of a mechanical system that automatically changes the filter.

### SUMMARY OF THE INVENTION

The present invention relates to a filtration system with a flip-flop, cross-flow function and to a filtration method, especially to a filtration system which uses a combination of cross-flow and dead end filtration to prevent cake formation in a filter. The present invention increases effective operation time and allows for continuous filtration operation without interruption.

Disclosed is a filtration system for processing samples for on-line analysis that increases time between filter changes while providing filtered samples that accurately represent the concentration of macromolecular species in industrial systems, including, but not limited to industrial water process systems. Additionally, the present invention provides for the system to capture representative solids at regular frequency and provide an on-line batch-wise sample concentration mechanism. This system can be tuned to capture material above the nominal pore size defined by the membrane, and flow times can be used to define the desired concentration factor.

In one embodiment of the present invention, a filtration system for processing samples for on-line sample analysis with a flip-flop function that flips flow back and forth between the sides at a frequency that minimizes filter cake formation, prevents macromolecular adsorption, and provides filtered samples that accurately represent the concentration of macromolecular species in industrial water and process systems is disclosed. The filtration system comprises a supply line, two opposing filters with a central collection chamber, a central filtered sample line, a drain line, and a flow control system to control flow direction. The flip-flopping occurs at a frequency that prevents macromolecular adsorption and this frequency can be adjusted and tweaked until a best-case scenario is realized. This process results in macromolecular concentration gradients that can be maintained below acceptable tolerances, with the gradient tolerance defined by the flipping frequency designated in the system. A flow control system consisting of multiple solenoid valves can be used to achieve the flow direction regulation as described above. A combination of commercially available two-port valves and multiple-port valves can be chosen. Ideally, a specially designed manifold consisting of multiple channels and a single integrated multiple-port valve can be made to achieve an optimal flow control system that is specific to the flow regulation needs as described.

In another embodiment, a cross-flow function is added to the previously described flip-flop system. This system provides an additional cross flow of fluids at a higher velocity to shear materials off the surface of the exit or drain line side of a dual filter while the sample filter is being performed on the opposite side. The combination of backflow through the membrane as a result of the flip-flopping and cross-flow across the membrane enhances and speeds cake removal, allowing the membrane to return to a cleaner state sooner. This allows for longer run times than those obtained with a system with only a backflow design or only a cross-flow design. The combination of flip-flop and cross flow enhances the lifetime of the filtration system. The integration of the alternating cross flow where the sample is extracted between two membranes allows for both continuous sampling and continuous cleaning.

An additional embodiment of the present invention discloses a system that captures representative solids at a regular frequency and provides an on-line batch-wise sample concentration mechanism. This system can be tuned to capture material above the nominal pore size defined by the membrane, and flow times can be used to define the desired concentration factor. This system comprises the addition of an actuator valve driven sampling system, which can be used to provide on-line concentrated solids samples that are produced at regular frequencies. The filtration process for such an embodiment proceeds as set forth above in the combination flip-flop and cross flow device and system, with the exception that instead of sending the cross flow or counter flow wash to waste, a system of valves collects the suspended cross flow or counter flow filter cake samples as they are liberated from a filter surface. A quick through filter fluid pulse gently loosens formed sample cake from the filter material, while a subsequent cross flow or counter flow transfers liberated cake to a sample collection vessel.

The various features of novelty which characterize the invention are pointed out with particularity in the claims annexed to and forming a part of this disclosure. For a better understanding of the invention, its operating advantages and benefits obtained by its uses, reference is made to the accompanying drawings and descriptive matter. The accompanying drawings are intended to show examples of the many forms of the invention. The drawings are not intended as showing the limits of all of the ways the invention can be made and used. Changes to and substitutions of the various components of the invention can of course be made. The invention resides as well in sub-combinations and sub-systems of the elements described, and in methods of using them.

### BRIEF DESCRIPTION OF THE DRAWINGS

FIG. 1a is an illustration of a filtration system in its initial stage in accordance with an embodiment of the invention;

FIG. 1b is an illustration of a filtration system after a cake is formed on the filter in accordance with an embodiment of the invention;

FIG. 1c is an illustration of a filtration system once the flip action has occurred in accordance with an embodiment of the invention;

FIG. 1d is an illustration of a filtration system upon initiation of cross-flow in accordance with an embodiment of the invention;

FIG. 1e is an illustration of a filtration system after the filter cake is flushed in accordance with an embodiment of the invention;

FIG. 1f is an illustration of a filtration system once the cross flow has ceased in accordance with an embodiment of the invention;

FIG. 1g is an illustration of a filtration system after filter cake is formed on the filter in accordance with an embodiment of the invention;

FIG. 1h is an illustration of a filtration system once flip-flop action has occurred in accordance with an embodiment of the invention;

FIG. 1i is an illustration of a filtration system upon initiation of cross-flow in accordance with an embodiment of the invention;

FIG. 1j is an illustration of a filtration system after the filter cake is flushed in accordance with an embodiment of the invention;

FIG. 1k is an illustration of a filtration system that has returned to beginning state in accordance with an embodiment of the invention; and

FIG. 2 is an illustration of a filtration system that includes a system of valves and a sample collection vessel in accordance with an embodiment of the invention.

### DETAILED DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

The singular forms “a,” “an” and “the” include plural referents unless the context clearly dictates otherwise.

The present invention discloses and claims a filtration system 100 with a flip-flop, cross-flow function and a filtration method, especially a filtration system 100 which uses a combination of dead end filtration across opposing membranes with a sample take-off in the middle, and cross-flow to prevent cake 170, 175 formation on these opposing filters 150, 155. The present invention increases effective operation time and allows for continuous filtration operation without interruption. Also disclosed is a system 100 for processing samples for on-line analysis that increases time between filter 150, 155 changes while providing filtered samples that accurately represent the concentration of macromolecular species in industrial systems, including, but not limited to industrial water process systems.

This invention allows for increased run time before servicing is required. This could extend filtration lifetime from hours to several months. In addition, the disclosed systems offer a novel way to concentrate and sample particulates and biological materials above a membrane cut-off dimension or membrane nominal pore size.

In one embodiment of the present invention, a filtration system 100 for processing samples for on-line sample analysis with a flip-flop function that flips flow back and forth between the sides at a frequency that minimizes filter cake 170, 175 formation, prevents macromolecular adsorption, and provides filtered samples that accurately represent the concentration of macromolecular species in industrial water and process systems is disclosed. The filtration system 100 comprises a supply line 110, two opposing filters with a central collection chamber 150, 155, a central filtered sample line 160, a drain line 120, and a flow control system to control flow direction. The flip-flopping occurs at a frequency that prevents macromolecular adsorption and this frequency can be adjusted and tweaked to reach optimal value. This process results in a macromolecular concentration gradient that can be maintained below acceptable tolerances. The gradient tolerance can be defined by the flipping frequency designated in the filtration system 100. The filters 150, 155 prevent large size particles from entering the water process and damaging the equipment and remove larger particulate matter from inlet water to prevent clogging of the pump and other fluidic components. The size of the particles that the filters 150, 155 allow through vary depending on the water system involved and the filter pore size selected. Matching a filter pore size to a particle size distribution in a sample stream and the flip-flop frequency provides more tools to better optimize the filtration system 100.

A flow control system consisting of multiple solenoid valves 130, 135, 140, 145 can be used to achieve the flow direction regulation as described above. A combination of commercially available two-port valves and multiple-port valves can be chosen. Ideally, a specially designed manifold consisting of multiple channels and a single integrated multiple-port valve can be made to achieve an optimal flow control system that is specific to the flow regulation needs as described. In one embodiment, the flow control system consists of multiple valves 130, 135, 140, 145 and multiple flow channels that control the flow directions of at least two flow streams. In an alternate embodiment, the flow control system is a manifold consisting of a single valve with multiple ports and multiple flow channels that control the flow directions of at least two flow streams.

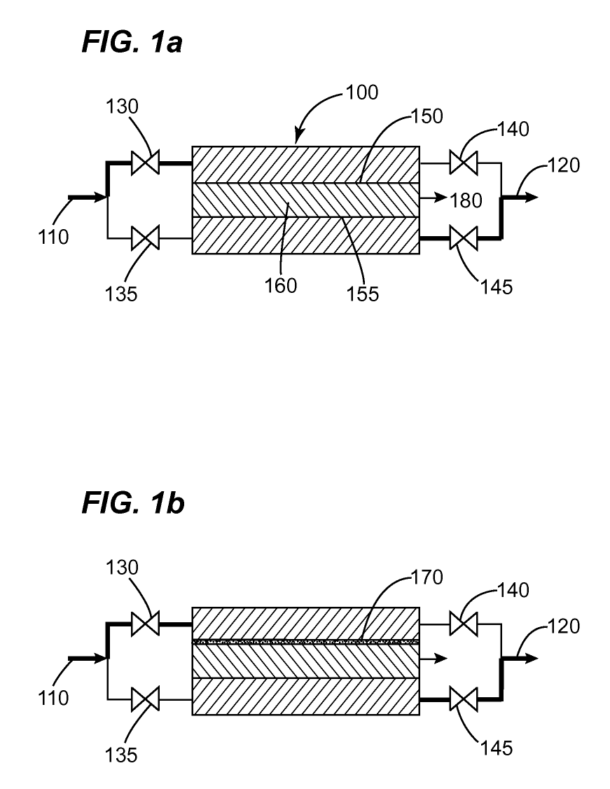

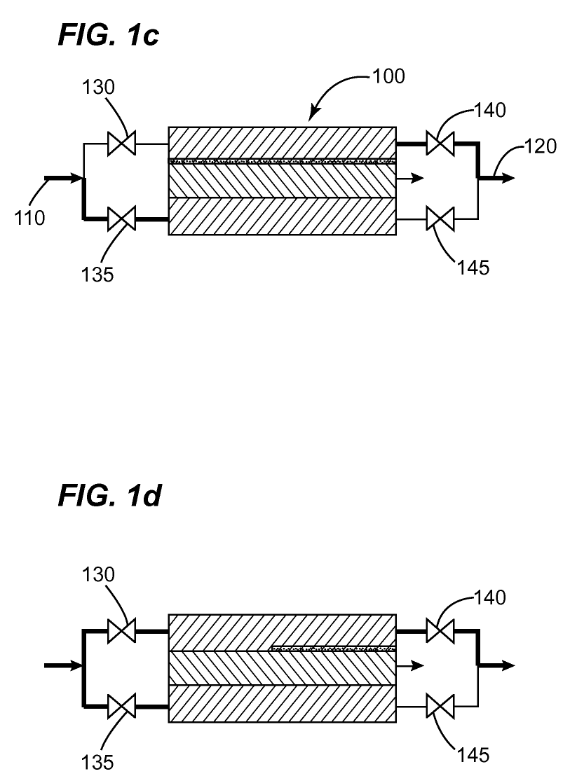

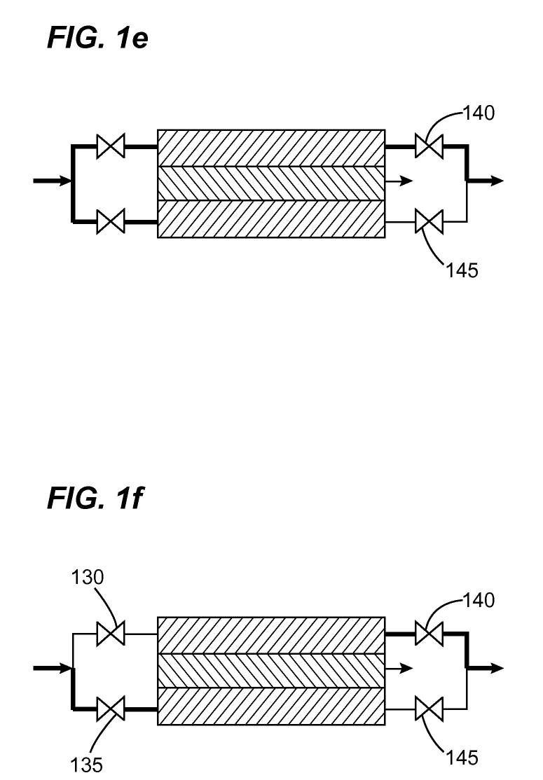

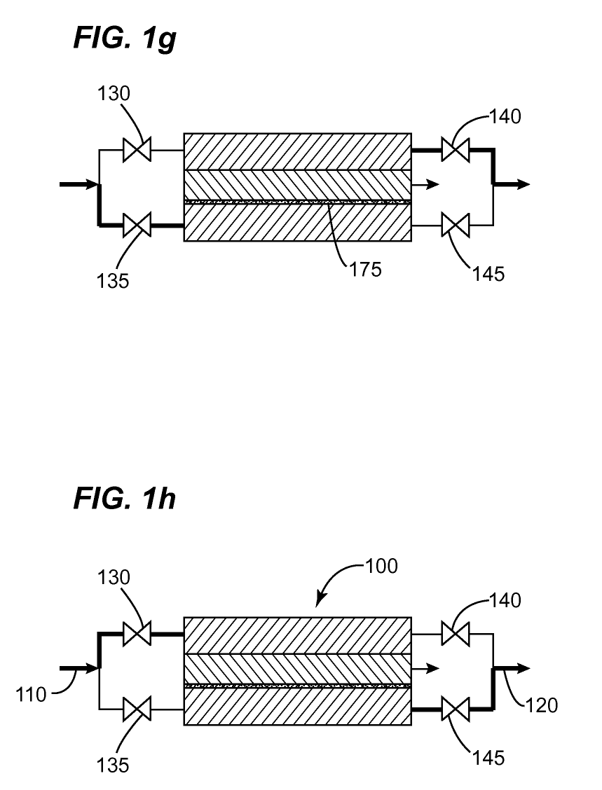

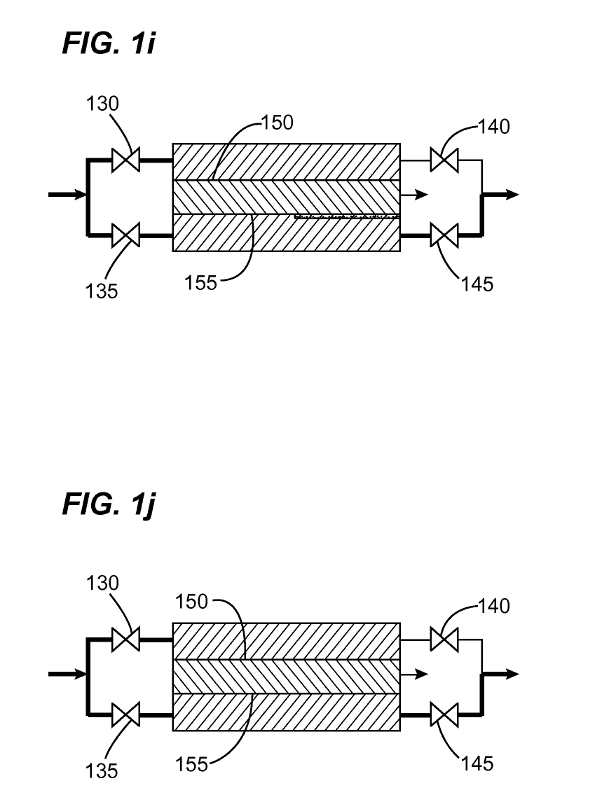

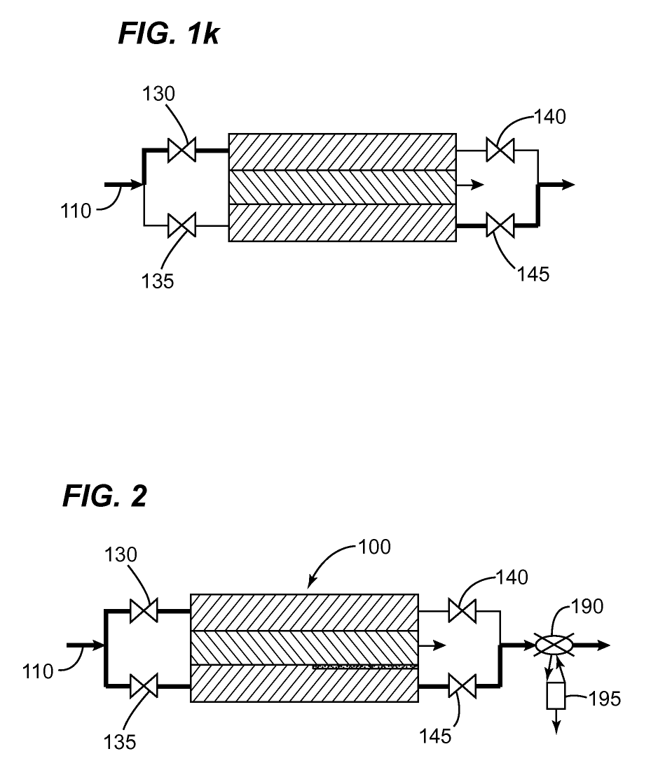

Refer now to the figures, which are meant to be exemplary and not limiting, in which like reference numerals are used to indicate the same or related elements and not all numbers are repeated in every figure for clarity of the illustration. FIG. 1a illustrates a system 100 for processing samples, such as water, for on-line analysis. In this figure, the system 100, is in its initial phase, and illustrates the supply line 110, the drain line 120, valves 130, 135, 140, 145, filters 150, 155, and a central filtered sample line 160. Upon commencement of use of the system 100, the water flows through a high pressure supply line 110, through valve 130, and then through the filters 150 and 155, to exit through valve 145 and to the drain 120. Valves 135 and 140 are closed during this process. A filtered sample flows from the center filtered sample line 160 and is indicated as filtrate 180.

In FIG. 1b, the system 100 has been in use for a while and a filter cake 170 has been formed on filter 150. As the membrane clogs with cake 170, flow slows down, resulting in a bad representative sample. At this point, the flip-flop action, or the change to the alternate filter occurs. As shown in FIG. 1c, on the inlet or supply line 110 side of the system 100, valve 130 is now closed and valve 135 is open, and on the exiting or drain line 120 side of the system 100, valve 140 is now open and valve 145 is now closed. This flip-flop action pushes the cake 170 off the filter 150 and reestablishes flow.

This process continues in a back and forth sequence to clear the clogging by the cake 170, 175, with opposing filter 155 being used. Once a filter cake 175 has built up or formed on filter 155, the process outlined above is followed but with the opposite flow action. Instead of valve 145 being closed and 140 being open, valve 145 is open, and valve 140 is closed.

In FIG. 1g, a filter cake 175 has been formed on filter 155. Valves 135 and 140 remain open, and valves 130 and 145 remain closed. Once again, at this point, the flip flop action, or the change to the alternate filter occurs. As shown in FIG. 1h, on the inlet or supply line 110 side of the system 100, valve 135 is now closed and valve 130 is open, and on the exiting or drain line 120 side of the system 100, valve 145 is now open and valve 140 is now closed. As the figures illustrate, water is supplied through one open valve 130, 135 and proceeds through a first filter 150, then a second filter 155, out another valve 140, 145, and then out the drain line 120. Once a filter cake 170, 175 forms on the first filter 150, the two valves that are open are closed and two closed valves are now open, resulting in a flip-flop action, forcing the filtration of the water to proceed in the opposite direction, such that the water proceeds through a second filter prior to the first filter.

In another embodiment of the present invention, a filtration system 100 for processing samples for on-line sample analysis with a combination flip-flop, cross flow function, which uses both reverse flow and cross-flow to prevent cake formation in a filter is disclosed. The filtration system 100 is comprised of a supply line 110, two opposing filters with a central collection chamber 150, 155, a central filtered sample line 160, a drain line 120, and a flow control system to control flow direction. In this embodiment, cross-flow is added to the previously described flip-flop system. This system 100 provides an additional cross flow at a higher velocity to shear materials off the surface of the exit or drain line 120 side of a dual filter while the sample filter is being performed on the opposite side. The combination of backflow through the caked membrane as a result of the flip-flopping and cross-flow across the membrane surface enhances and speeds cake 170, 175 removal, allowing the membrane to return to a cleaner state sooner. This allows for longer run times than those obtained with a system with only backflow design or only a cross-flow design. The combination of flip-flop and cross flow enhances the lifetime of the filtration system 100. The integration of the alternating cross flow where the sample is extracted between two membranes allows for both continuous sampling and continuous cleaning. In one embodiment, the flow control system consists of multiple valves 130, 135, 140, 145 and multiple flow channels that control the flow directions of at least two flow streams. In an alternate embodiment, the flow control system is a manifold consisting of a single valve with multiple ports and multiple flow channels that control the flow directions of at least two flow streams.

As previously detailed, FIG. 1a illustrates a system 100 for processing samples for on-line analysis. Illustrated in FIG. 1d is the initiation of cross flow of water across filters 150, 155. During this stage, valves 130, 135 and 140 are in the open position, leaving only valve 145 in the closed position. FIG. 1e illustrates that as a result of the cross flow, the filter cake is flushed. As shown in FIG. 1f, the cross flow is stopped, which requires valve 130 to now be closed.

This process continues, but with opposing filter 155 being used, which necessitates that valves 135 and 140 remain open, and valves 130 and 145 remain closed. Once a filter cake 175 has built up or formed on filter 155, the process outlined above is followed but with the opposite cross flow action, such that instead of valve 145 being closed and 140 being open, valve 145 would be open, and valve 140 would be closed.

In FIG. 1g, filter cake 175 has formed on filter 155. Once again at this point, the flip flop action, or the change to the alternate filter occurs. As shown in FIG. 1h, on the inlet or supply line 110 side of the system 100, valve 135 is now closed and valve 130 is open, and on the exiting or drain line 120 side of the system 100, valve 145 is now open and valve 140 is now closed.

In FIG. 1i, cross flow of water across filters 150, 155 is initiated. During this stage, valves 130, 135 and 145 are in the open position, leaving only valve 140 in the closed position. FIG. 1j illustrates that as a result of the cross flow, the filter cake is flushed, and then as shown in FIG. 1k, the cross flow is stopped and the system 100 returns to its beginning state, which requires valve 135 to now be closed. As the figures illustrate, water is supplied through one open valve and proceeds through a first filter, then a second filter, out another valve, and then out the drain line 120. Once a filter cake 170, 175 forms on the first filter, the two valves that are open are closed and two closed valves are now open, resulting in a flip-flop action, forcing the filtration of the water to proceed in the opposite direction, such that the water proceeds through a second filter prior to the first filter. Also, when the two valves 130, 135 on the supply line 110 side are both open, and one valve on the drain line 120 side is open, this forces a cross flow of the water to commence at the same time as a through-filter flow. The combination of through filter and cross flow results in enhanced flushing of the filter cake 170, 175, and then once cross flow of the water is stopped, only two opposing valves remain open.

Both the flip-flop filtration system and the combination flip-flop, cross flow filtration system provide representative samples to on-line analyzers for much longer times than were previously capable due to the fact that the systems continuously clean one filter 150, 155 while the other or opposing filter 150, 155 is being used for sampling. This periodic switching between the filters 150, 155 or sides of the system 100 allows the filter life to be extended from minutes in some cases to months before filters 150, 155 need to be replaced. In addition, both the flip-flop filtration system and the combination flip-flop, cross flow filtration system generate a more representative sample with acceptable macromolecular concentrations that more accurately represent the system being tested. Additionally, the frequency required for service of each analyzer filtration system is minimized.

A short pulse through the filter cake 170, 175 prior to cross flow can greatly enhance the efficiency of this system 100. The counter flow through the membrane helps dislodge solids in the membrane pore so that the solids can be removed by the cross flow. A continuous counter flow will flow through the section with the least resistance, while still having the potential to leave pores clogged. Cross-flow alone may not be able to liberate materials from the pores by a simple shear forces, but a combination of flip-flop and cross-flow has a greater probability of clearing more pores and allowing longer run times before a cake 170, 175 removal process is required. In addition, where the solids are collected, the present invention allows batch-wise testing to become automated batch.

In an additional embodiment of the present invention, a filtration system 100 for processing samples for on-line sample analysis with a combination flip-flop, cross-flow function, which uses both reverse flow and cross-flow to prevent cake 170, 175 formation in a filter 150, 155 is disclosed. This filtration system 100 is comprised of a supply line 110, two opposing filters with a central collection chamber 150, 155, a central filtered sample line 160, a drain line 120, a flow control system to control flow direction, and valves to collect 190 flushed filter cake as it is liberated from the filter surface.

This filtration system 100 provides for the system 100 to capture representative solids at a regular frequency by measuring the flows during the cake 170, 175 collection and subsequent cake 170, 175 release process, thereby creating a concentration mechanism. In addition, the system 100 provides an on-line batch-wise sample concentration mechanism which allows a user to calculate a concentration factor and use the concentration factor to calculate the total concentration of organic, inorganic, or biological particles concentration in the original flow. The concentration mechanism allows time averaged sampling and measures concentrations in the original sample that would be below the detection limits of an analyzer if the sample had not been concentrated. This system 100 can be tuned to capture material above the nominal pore size defined by the membrane, and flow times can be used to define the desired concentration factor. The concentration factor is the ratio of the filtered water to the suspended solid particulate sampling rate at the particulate valve.

This filtration system 100 comprises the addition of an actuator valve driven sampling system, which can be used to provide on-line concentrated solids samples that are produced at regular frequencies. The filtration process for such an embodiment proceeds as set forth above in the combination flip-flop, cross flow filtration system, with the exception that instead of sending the cross flow or counter flow wash to waste, a system of valves 190 collects the suspended cross flow or counter flow filter cake samples as they are liberated from a filter surface. A quick through filter fluid pulse gently loosens the sample cake 170, 175 from the filter material, while a subsequent cross flow or counter flow transfers the liberated cake to a sample collection vessel 195, as illustrated in FIG. 2. The ratio of the total flow through the filter while sampling to the total pulse and back flow to the collection vessel 195 or collection reservoir provides a concentration factor for the sample. Accurate knowledge or measurements of flows and times produces concentrated samples that may be used for downstream measurements. Again, the particulate size of the concentrated samples may be defined by the pore size of the membranes used in the system 100.

The filtration systems 100 described above can be optimized for a particular stream. A user can adjust the flow rate of the stream going through the system 100. Depending on the stream, the filtration system 100 can be adjusted to have either more cross flow or more dead end going through. As will be understood by one of ordinary skill in the field, the operation of the flow control system can be controlled automatically by a controller. In one embodiment, the stream flow may be adjusted by a simple timer-based controller. In another embodiment, the flow may be adjusted by a microprocessor. For example, these systems 100 can be tuned to capture material above the nominal pore size defined by the membrane, and flow times controlled by the microprocessor can be used to define the desired concentration factor.

The presently described filtration systems 100 can be constructed as a single unit where all flipping and cross flow is controlled by external actuated valves. This allows for a quickly replaceable filter unit for ease of service. In one embodiment, the sampling system may be part of an integrated on-line monitoring system. In an alternate embodiment, the system 100 may be used as a stand-alone sampling system.

The filtration systems 100 disclosed allow for either composite sampling or fractionated sampling. Composite sampling is a technique whereby multiple small samples are taken from a large flow over time, are combined, and treated as a single sample. This technique is frequently performed in wastewater in order to determine the average concentration over a specified amount of hours or days. A composite sampler collects a small sample every few minutes and adds it to a pooled sample container. After multiple cycles, the sample is removed and tested. The result shows the average of all the samples taken and is called a composite sample. Most discharge limits are based on time-averaged concentrations, and a composite sample provides the time-averaged sample. Fractionated sampling is similar to composite sampling, except each periodic sample is kept separate, and analyzed separately. A fractionated sampler takes a small sample over a specified period of time, and assumes a stable process. Then a temporal profile of the test results shows process change over time.

The embodiments of these systems 100 can be used to sample any water or process system where particulates are at a concentration below what represents the best concentration for analysis, i.e. particle size analysis. The concentration factor also benefits analyzers that are looking for lower concentration materials that are intermixed in diverse samples of varying sizes. The particular embodiments described above are ideally suited for sampling industrial water process systems as well as biological systems, where target organisms are usually at low concentrations and intermixed with higher concentrations of inorganic, organic or biological materials.

The invention is illustrated in the following non-limiting examples, which are provided for the purpose of representation, and are not to be construed as limiting the scope of the invention. All parts and percentages in the examples are by weight unless indicated otherwise.

### EXAMPLE 1

A functioning flip-flop, cross-flow prototype has been built and shown to work in the lab with high solids material and 30 um screens as filters. The size of the membrane is defined by the particle size distribution in the sample and the desired flowrate required for the analyzer. There are unlimited combinations of membrane pore sizes and flows that may be used. Examples of high solids materials include, but are not limited to, clay, silt, sand, silicates, diatomaceous earth, glass or silica beads.

### EXAMPLE 2

A cooling tower water sample is pumped through a conventional cross-flow filter with a 0.22 micron polyethersulfone membrane at a constant filtrate flow rate of 2 ml/min filtrate flow rate and a 1000 ml/min of cross flow. The sample water contains 7.2 to 24 ppm GE cooling tower treatment polymer. In the first 2 days, the polymer passage through the membrane was 88%. After 6 days in operation, a thin cake layer formed on the membrane surface and the polymer concentration in the filtered water was reduced to 71% of that in the unfiltered sample stream. A brief backwash was conducted on the seventh day and the polymer passage was resumed to the initial value 88%. A series of tests were conducted for different water samples and at different filtrate flow rates. It was observed that the higher filtrate flow rate required the higher backwash frequency. This demonstrates that although the filter can provide a sufficient volumetric flow to an analyzer, the cake formation on the membrane prevents the soluble polymeric material from passing through the membrane.

While the present invention has been described with references to preferred embodiments, various changes or substitutions may be made to these embodiments by those ordinarily skilled in the art pertinent to the present invention with out departing from the technical scope of the present invention. Therefore, the technical scope of the present invention encompasses not only those embodiments described above, but also all that fall within the scope of the appended claims.

What is claimed is:

1. A filtration system for processing samples for on-line sample analysis with a flip-flop function that flips flow back and forth between the sides at a frequency that minimizes filter cake formation, prevents macromolecular adsorption, and provides filtered samples that accurately represent the concentration of macromolecular species in industrial water and process systems, comprising:
a. a supply line;
b. two opposing filters with a central collection chamber;
c. a central filtered sample line;
d. a drain line; and
e. a flow control system to control flow direction.

2. The system of claim 1 wherein the flow control system consists of multiple valves and multiple flow channels that control the flow directions of at least two flow streams.

3. The system of claim 1 wherein the flow control system is a manifold consisting of a single valve with multiple ports and multiple flow channels that control the flow directions of at least two flow streams.

4. The system of claim 1, wherein water is supplied through one open valve and proceeds through a first filter, then a second filter, out another valve, and then out the drain line.

5. The system of claim 4 wherein once a filter cake forms on the first filter, the two valves that are open are closed and two closed valves are now open, resulting in a flip-flop action, forcing the filtration of the water to proceed in the opposite direction, such that the water proceeds through the second filter prior to the first filter.

6. The system of claim 1 wherein the flip-flopping frequency is adjusted to reach optimal value.

7. The system of claim 1 wherein the system results in a macromolecular concentration gradient that is maintained below acceptable tolerances.

8. The system of claim 7 wherein the macromolecular concentration gradient tolerance is defined by the flip-flopping frequency designated in the filtration system.

9. A filtration system for processing samples for on-line sample analysis with a combination flip-flop, cross-flow function, which uses both reverse flow and cross-flow to prevent cake formation in a filter, comprising:
a. a supply line;
b. two opposing filters with a central collection chamber;
c. a central filtered sample line;
d. a drain line; and
e. a flow control system to control flow direction.

10. The system of claim 9 wherein the flow control system consists of multiple valves and multiple flow channels that control the flow directions of at least two flow streams.

11. The system of claim 9 wherein the flow control system is a manifold consisting of a single valve with multiple ports and multiple flow channels that control the flow directions of at least two flow streams.

12. The system of claim 9, wherein water is supplied through one open valve and proceeds through a first filter, then a second filter, out another valve, and then out the drain line.

13. The system of claim 12 wherein once a filter cake forms on the first filter, the two valves that are open are closed and two closed valves are now open, resulting in a flip-flop action, forcing the filtration of the water to proceed in the opposite direction, such that the water proceeds through the second filter prior to the first filter.

14. The system of claim 13 wherein the two valves on the supply line side are both open, and one valve on the drain line side is open, forcing a cross flow of the water to commence at the same time as a through-filter flow.

15. The system of claim 14 wherein the combination of through filter and cross flow results in enhanced flushing of the filter cake, and then cross flow of the water is stopped, and only two opposing valves remain open.

16. A filtration system for processing samples for on-line sample analysis with a combination flip-flop, cross-flow function, which uses both reverse flow an cross-flow to prevent cake formation in a filter, comprising:
a. a supply line;
b. two opposing filters with a central collection chamber;
c. a central filtered sample line;
d. a drain line;
e. a flow control system to control flow direction; and
f. valves to collect flushed filter cake as it is liberated from the filter surface.

17. The system of claim 16 wherein the flow control system consists of multiple valves and multiple flow channels that control the flow directions of at least two flow streams.

18. The system of claim 16 wherein the flow control system and the valve to collect flushed filter cake is a manifold consisting of a single valve with multiple ports and multiple flow channels that control the flow directions of at least two flow streams and a flow stream that collects the flushed filter cake.

19. The system of claim 16 wherein a quick through filter fluid pulse gently loosens the filter cake sample from the filter, while a subsequent cross flow or counter flow transfers the liberated cake to a sample collection vessel.

20. The system of claim 16 wherein the system is tuned to capture material above a nominal pore size defined by the membrane.

21. The system of claim 16 wherein the system captures representative solids at a regular frequency by measuring the flows during the cake collection and subsequent cake release process, thereby creating a concentration mechanism.

22. The system of claim 16 wherein the system provides an on-line batch-wise sample concentration mechanism which allows a user to calculate a concentration factor and use the concentration factor to calculate the total concentration of organic, inorganic, or biological particles concentration in the original flow.

23. The system of claim 16 wherein the concentration mechanism allows time averaged sampling and measures concentrations below the detection limits of an analyzer.

24. An integrated on-line monitoring system comprising the filtration system of claim 9.

25. The system of claim 9 wherein the system in an industrial water system.
